(19) United States
(12) Patent Application Publication
(10) Pub. No.: US 2023/0222931 A1
(43) Pub. Date: Jul. 13, 2023

(54) Toilet Training Timer System

(71) Applicant: Debbie Foster, Markham (CA)

(72) Inventor: Debbie Foster, Markham (CA)

(21) Appl. No.: 17/572,729

(22) Filed: Jan. 11, 2022

(51) Int. Cl. G09B 5/04; G09B 19/00

(52) U.S. Cl. CPC G09B 5/04; G09B 19/0076

(57) ABSTRACT

A system for toilet training a child includes a device and, in some embodiments, a software application configured for communication with the device. The device includes a housing, a display, a user interface, a recorder unit, a loudspeaker unit, and a control unit having a timer unit and a memory unit. The system is used for reminding a child to use the toilet at predetermined intervals throughout the day, thus enhancing and supporting parents in toilet training their children.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of toilet training of existing art and more specifically relates to a device and system used to enhance and support toilet training.

### RELATED ART

Toilet training or “potty training” is the process of training a young child to use the toilet. Toilet training is often a challenging task for both parents and children; it is important for the process not to stress or rush the child and for the parent to be encouraging as possible whilst keeping the process as fun and positive as they can. Whilst toilet training is individual to each child, the process typically involves the parent(s) reminding the child at intervals throughout the day to use the bathroom, whether that involves telling the child to sit on the toilet at intervals throughout the day or asking the child if they need to use the toilet at certain intervals throughout the day. A problem with this, however, is that it requires the parent to be consistent and constantly remember to remind the child. This is not always possible for parents who work, are not always present, or are otherwise busy. As such, a suitable solution is desired.

### SUMMARY OF THE INVENTION

In view of the foregoing disadvantages inherent in the known toilet training art, the present disclosure provides a novel toilet training timer system. The general purpose of the present disclosure, which will be described subsequently in greater detail, is to provide a system used for timing predetermined intervals and alerting a child when the predetermined interval has elapsed in order to remind them to use the toilet. Thus, the toilet training timer system aids in toilet training the child.

A system for toilet training a child is disclosed herein. The system includes a device having a housing, a display, a user interface, a recorder unit, a loudspeaker unit, a control unit and a power source configured to provide power to the device. The housing may include a front side opposite a rear side. The display may be located on the front side of the housing and the user interface may be located about the display. The recorder unit may be disposed within the housing and configured to record at least one voice message. The loudspeaker unit may be disposed within the housing and configured to audibly play at least one of the at least one voice message and at least one pre-recorded message.

The control unit may be disposed within the housing and in communication with the recorder unit and the loudspeaker unit. The control unit may include a timer unit and a memory unit, the memory unit configured to store the at least one of the at least one voice message and the at least one pre-recorded message. The timer unit may be configured to count down at least one predetermined time interval and cause the loudspeaker unit to play the at least one of the at least one voice message and the at least one pre-recorded message once the at least one predetermined time interval has elapsed. The timer unit may be automatically reset back to count down of the at least one predetermined time interval once the at least one the predetermined time interval has elapsed.

According to another embodiment, a method of using a system for toilet training a child is also disclosed herein. The method includes providing the system as above; setting the at least one predetermined time interval; selecting at least one of the at least one voice message and the at least one pre-recorded message, thereby allowing the loudspeaker unit to play the at least one of the at least one voice message and the at least one pre-recorded message once the at least one predetermined time interval has elapsed; and attaching the device to one of a wrist of the child, clothing of the child and a belonging of the child.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a toilet training timer system, constructed and operative according to the teachings of the present disclosure.

FIG. 1 is a perspective view of a device being worn on a wrist of a child, according to an embodiment of the disclosure.

FIG. 2A is a front view of the device of FIG. 1, according to an embodiment of the present disclosure.

FIG. 2B is a front perspective view of the device of FIG. 1, according to an embodiment of the present disclosure.

FIG. 2C is a side perspective view of the device of FIG. 1, according to an embodiment of the present disclosure.

FIG. 3 is a perspective view of a device being worn on clothing of a child, according to another embodiment of the disclosure.

FIG. 4A is a front view of the device of FIG. 3, according to another embodiment of the disclosure

FIG. 4B is a front perspective view of the device of FIG. 3, according to another embodiment of the disclosure.

FIG. 4C is a side perspective view of the device of FIG. 3, according to another embodiment of the disclosure.

FIG. 5 is a schematic diagram of the device, according to an embodiment of the present disclosure.

FIG. 6 is a perspective view of a system illustrating the device, a software application downloaded onto an external device and a sticker book, according to an embodiment of the disclosure.

FIG. 7 is a schematic diagram of the system, particularly illustrating the device and the software application downloaded onto the external device, according to an embodiment of the present disclosure.

FIG. 8 is a flow diagram illustrating a method of using a system for toilet training a child, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to toilet training devices and more particularly to a toilet training timer system used in reminding a child to use the toilet at predetermined intervals throughout the day, thus enhancing and supporting parents in toilet training their children. Generally, the toilet training timer system may include an interactive device that allows parents/guardians to customize a particular timing interval for the child. Further, the toilet training timer system may allow the parents/guardians to selectively record their voice and selectively choose a factory standard message and/or a voice of the child's favorite character. The standard messages may include a variety of different languages.

In some embodiments, the interactive device may include a wristwatch. In other embodiments, the interactive device may include a device attachable to clothing or a belonging of the child, such as a favorite blanket or stuffed toy. The interactive device may include a USB port and a battery for supplying power thereto. Preferably, the interactive device may include a reward setting. In this embodiment, the toilet training timer system may further include a sticker book. In addition to this, the toilet training timer system may include a software application to encourage toilet training in a fun and interactive way.

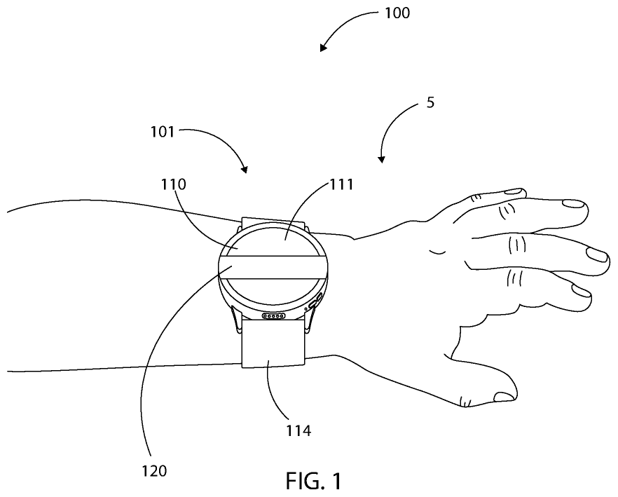

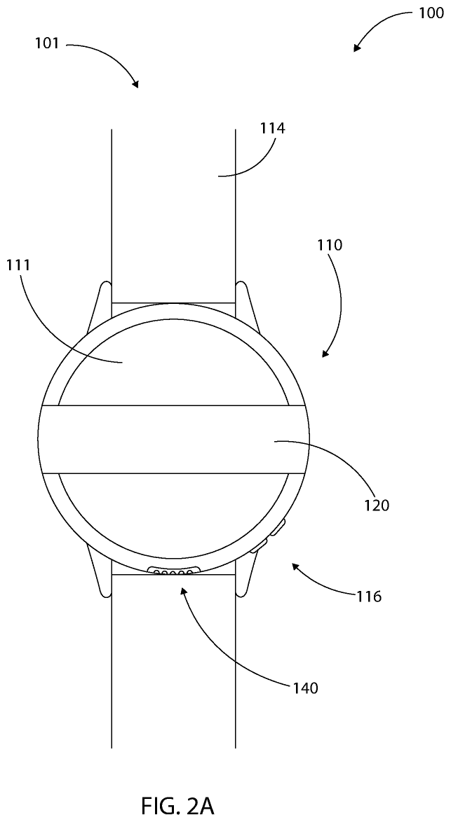

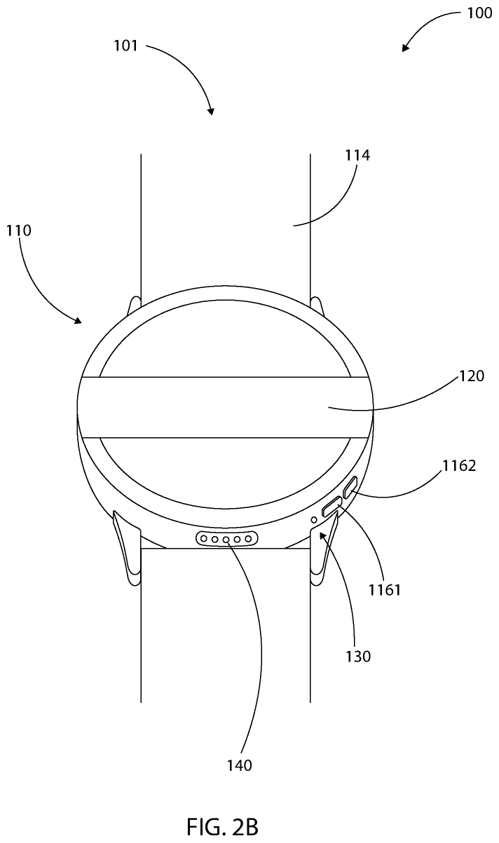

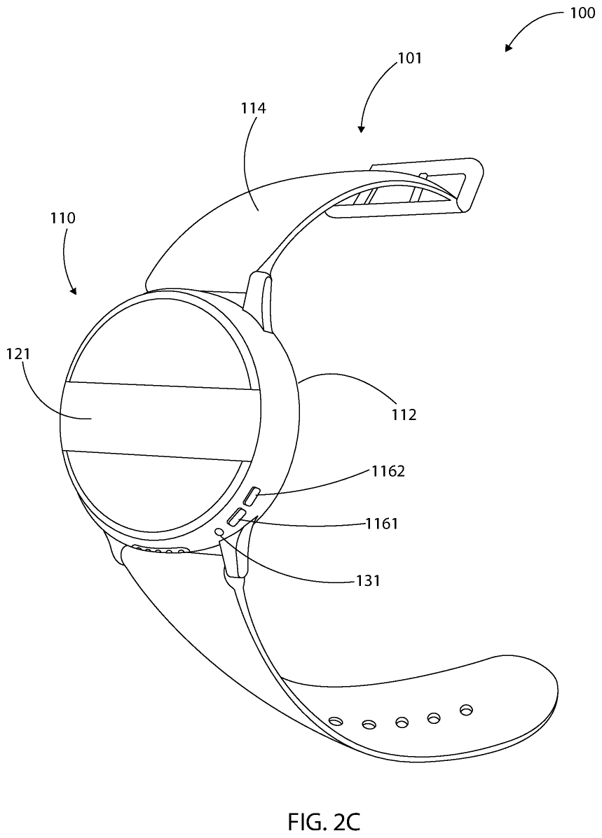

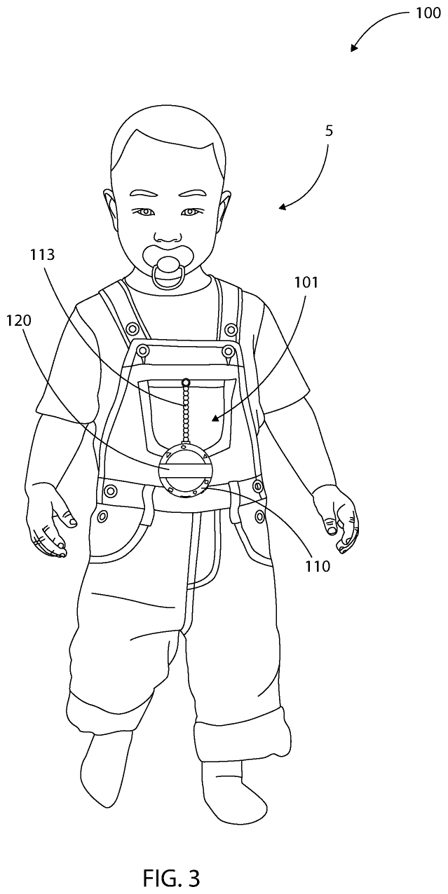

Referring now more specifically to the drawings by numerals of reference, there is shown in FIGS. 1-7, various views of a system 100. The system 100 may be particularly useful in toilet training a child 5. Particularly, as shown, the system 100 may include a device 101. As shown in FIG. 1 and FIG. 3, the device 101 may be worn on or at least close to the child 5 so that the child 5 is able to hear and/or see alerts output by the device 101. For example, as shown in FIGS. 1-2C, the device 101 may be arranged as a watch. In this embodiment, the device 101 may comprise a watch strap 114 configured for attachment to the housing 110 and configured to attach the device 101 to a wrist of the child 5.

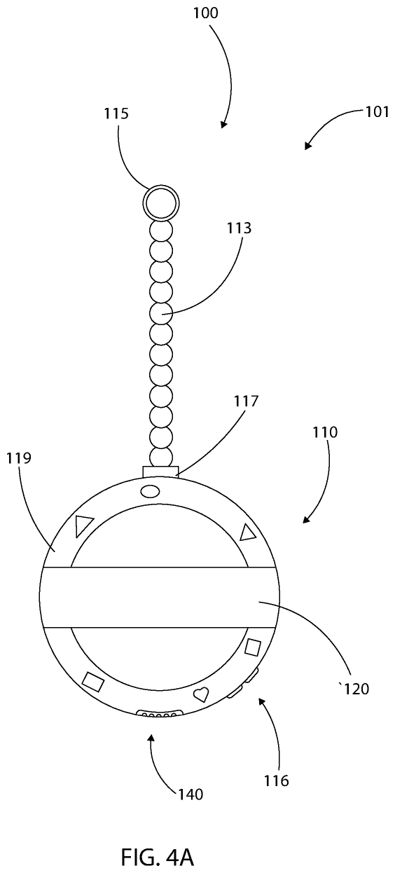

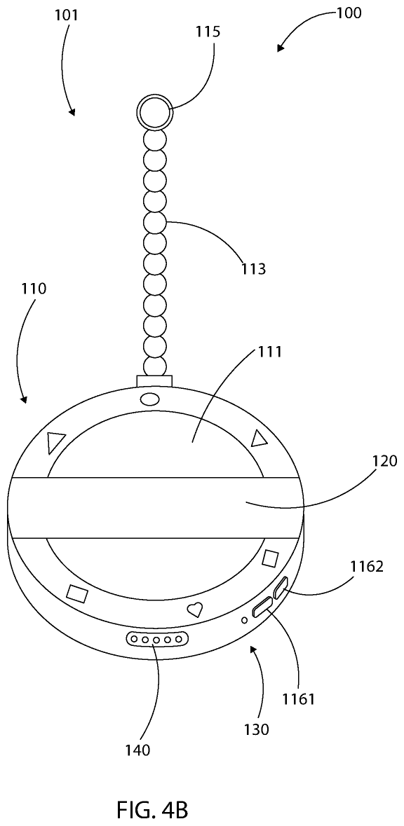

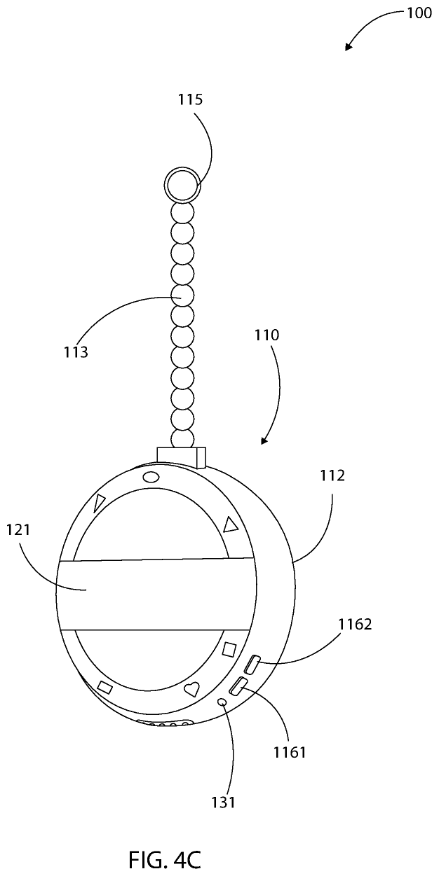

In other embodiments, as shown in FIGS. 3-4C, the device 101 may be configured to fasten to at least one of clothing of the child 5. In some embodiments, this device 101 may also fasten to a belonging of the child 5. For example, the belonging may be a blanket, a toy, or any other belonging that a parent may deem suitable. Particularly, the belonging may be one in which the child 5 carries with them often. In this embodiment, as shown, the strap 113 may include a fastener 115 configured to fasten the strap 113 thereto. In some examples, the fastener 115 may comprise a ring, such a key ring that can be easily attached to the clothing and/or belonging of the child 5. In some embodiments, the strap 113 may be permanently attached to the device 101. In other embodiments, the strap 113 may be removably attached to the device 101. In this embodiment, the strap 113 may include a device fastener 117 for fastening the strap 113 to the device 101. In some examples, this may also be a ring.

As shown in FIGS. 1-7, the device 101 may include a housing 110, a display 120, a recorder unit 130, a loudspeaker unit 140, a control unit 150 and a power source 160. As shown, the housing 110 may include a front side 111 opposite a rear side 112. The housing 110 may include a periphery defining a top side opposite a bottom side and a left side opposite a right side (relative to the child 5 when worn). Further, in some embodiments, the housing 110 may further include a decorative plate 119 (FIG. 4A) around the periphery thereof. As shown, the display 120 may be located on the front side 111 of the housing. In some embodiments, the display 120 may include a digital display 121.

The display 120 may be used for alerting the child 5 and/or to allow the parent to navigate functions and settings on the device 101. Further, the device 101 may comprise a user interface 116. In some examples, as shown in FIGS. 2B-2C and FIGS. 4B-4C, the user interface 116 may include buttons 1161, 1162 located about the display 120 on an exterior of the housing 110 and in communication with the control unit 150. In additional examples, the user interface 116 may be integral to the display 120. For example, the user interface 116 may include the device 101 having a touch screen (not illustrated).

The recorder unit 130 may be disposed within the housing 110 and configured to record at least one voice message. In some embodiments, the recorder unit 130 may be a digital voice recorder configured to convert sounds into a digital file. As such, the recorder unit 130 may comprise a microphone 131 configured to capture the sounds. As shown, the microphone 131 may include a small aperture in the exterior of the housing 110. Preferably, the at least one voice message may include spoken messages from the parent. The loudspeaker unit 140 may be disposed within the housing 110 and configured to audibly play the at least one voice message.

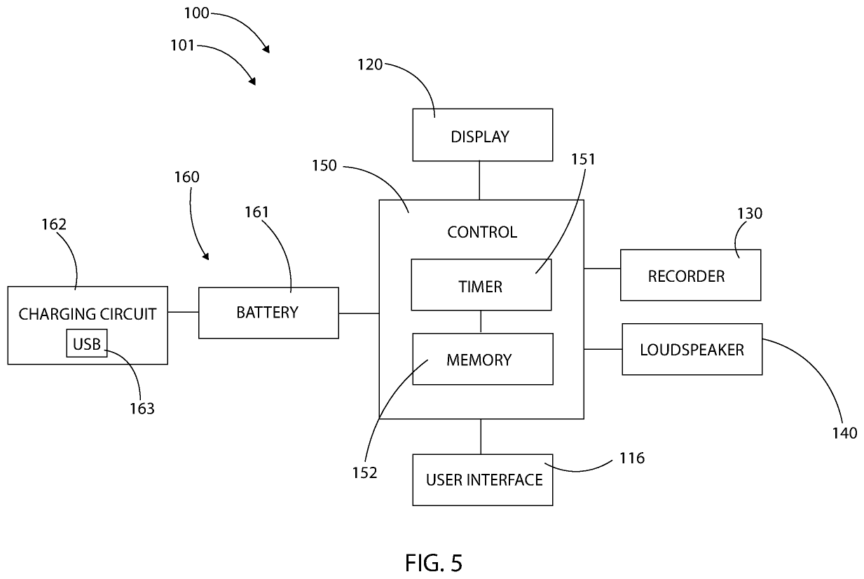

Referring more particularly to FIGS. 5-7, the control unit 150 may be disposed within the housing 110 and in communication with the recorder unit 130 and the loudspeaker unit 140. The control unit 150 may include a timer unit 151 and a memory unit 152. The control unit 150 may include at least one processor. The memory unit 152 may be configured to store the at least one voice message. Preferably, the memory unit 152 may be configured to store a plurality of voice messages so that the parent is able to store and use a variety of different messages for the child 5. Preferably, the parent may utilize the user interface 116 to begin recording of the at least one voice message. They may then utilize the user interface 116 to playback and/or save the at least one voice message (via the at least one processor).

In addition, in some embodiments, the memory unit 152 may be configured to store at least one pre-recorded message, and as such, the loudspeaker unit 140 may also be configured to audibly play the at least one pre-recorded message. Again, preferably, the at least one pre-recorded message may be a plurality of pre-recorded messages. In some examples, the pre-recorded message(s) may include standard messages, songs, or the like. The standard messages may include voices of the child's favorite characters. Preferably, the pre-recorded messages may be provided in a variety of languages.

In some embodiments, the timer unit 151 may be integral to the at least one processor. In some embodiments, the at least one processor may include one processor configured to execute all actions of the device 101 (including actions of the timer unit 151). In other embodiments, the at least one processor may include more than one processor: one configured to execute timer unit 151 actions and one (or more) to execute all other actions of the device 101. The timer unit 151 may be configured to count down at least one predetermined time interval and cause the loudspeaker unit 140 to play the at least one of the at least one voice message and the at least one pre-recorded message once the at least one predetermined time interval has elapsed. For example, the parent may choose a time interval of one hour.

The timer unit 151 may automatically reset back to count down of the at least one predetermined time interval once the at least one the predetermined time interval has elapsed. For example, once the hour has passed, the timer unit 151 may anatomically begin counting down another hour. This may be set via the user interface 116. Further, in some embodiments, the parent may choose a time interval for the timer unit 151 to switch on and off. For example, the time interval of one hour may begin at 7 AM and end at 8 PM every day. In some embodiments, again, this may be set via the user interface 116.

In use, the parent may set the at least one predetermined time interval and either record a voice message or choose a pre-recorded voice message or a pre-recorded message and assign the chosen message to the at least one predetermined time interval. For example, a “time for potty” in the parent's voice may be assigned to the one hour interval. The timer unit 151 may then begin counting down the at least one predetermined time interval (again, for example, one hour). Once the at least one predetermined time interval, the control unit 150 may signal the loudspeaker unit 140 to audibly play the chosen message to alert the child 5 that it is time to go sit on the toilet. It should be appreciated that the loudspeaker unit 140 may not be the only means of alerting the child 5. For example, in some embodiments, the display 120 may display a message, and/or the device 101 may vibrate.

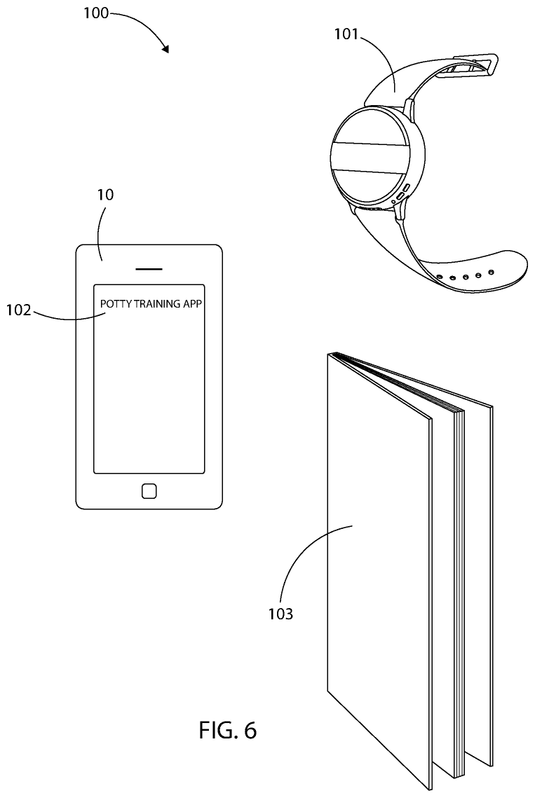

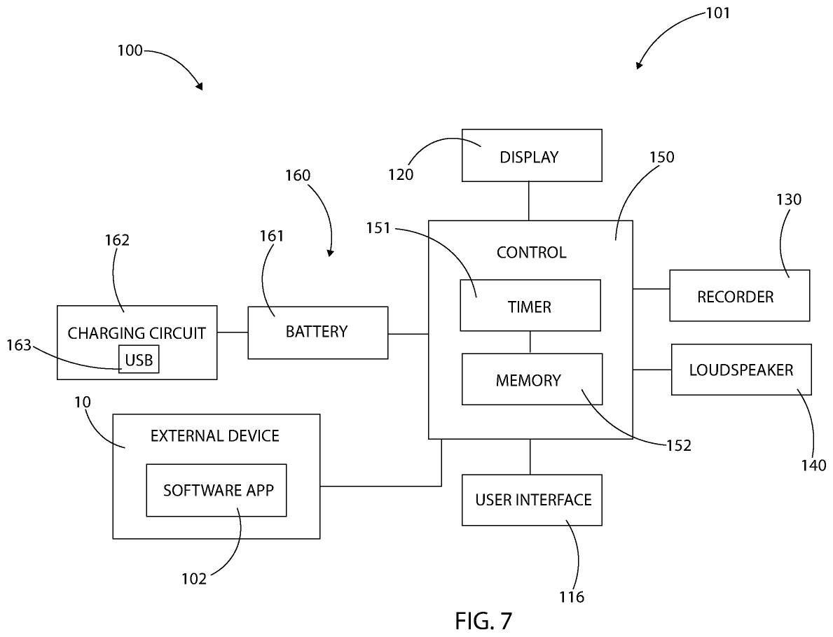

In some embodiments, as shown in FIGS. 6-7, the system 100 may further comprise a software application 102 configured for communication with the device 101. The software application 102 may be downloadable to and/or useable on an external device 10, such as a smartphone, tablet computer, laptop computer, desktop computer, or the like. In this embodiment, the device 101 may comprise a communication means, such as a transceiver for facilitating communication between the software application 102 and the device 101.

In some embodiments, the software application 102 may be used in addition to or instead of the user interface 116 as described above. For example, one or both of the user interface 116 and the software application 102 may be used for recording messages, for setting messages, for setting time intervals, and the like. For instance, the parent may record a message via a recording system integral with their external device 10. In this embodiment, the system 100 may further comprise a server having a processor, a memory and a database for storing messages, time intervals and information pertaining to the child 5.

Further, in some embodiments, the system 100 may comprise a ‘reward setting’. In this embodiment, the system 100 may further comprise a sticker book 103, as illustrated in FIG. 6, to allow the parent to reward the child 5 if a successful toilet training task is completed. This may be a physical sticker book 103 (as shown in FIG. 6), and/or may be a virtual sticker book which may be displayed on the device 101 and/or the software application 102 (on the external device 10). In this embodiment, the control unit 150 may be configured to receive information regarding completion of a toilet training task and actuate a reward setting based on the information. In some embodiments, the information may be received via the device 101 (user interface 116) or via the software application 102 and manually input by the parent. In other embodiments, the device 101 may comprise a sensing means (such as audio sensor or motion sensor) to establish successful use of the toilet. In other embodiments, the information may be an elapsed time interval (as counted down by the timer unit 151).

In some embodiments, the at least one of the at least one recorded message and the at least one pre-recorded message may include at least one reward message and the reward setting may include the control unit 150 causing the loudspeaker unit 140 to audibly play the at least one reward message. For example, if the child 5 uses the toilet successfully, the device 101 may play the reward message (such as “well done” in the parent's voice, a positive tune, applause, etc.) to encourage and positively reinforce the act of using the toilet for the child 5.

In some examples, the device 101 may play the reward message after a predetermined amount of time has elapsed. In this example, after the timer unit 151 has counted down the at least one predetermined time interval and the control unit 150 has caused the loudspeaker unit 140 to play the at least one of the at least one recorded message and the at least one pre-recorded message to remind the child 5, the timer unit 151 may be configured to begin count down of a reward time interval (for example, 5 minutes). Once the reward time interval has elapsed, the control unit 150 may cause the loudspeaker unit 140 to play the at least one reward message. This may congratulate the child 5 if they were able to use the toilet or encourage the child 5 if they are still trying.

The power source 160 may include at least one rechargeable battery 161. In this embodiment, the device 101 may include a charging circuit 162 disposed in the housing 110. The charging circuit 162 may include at least one of a transformer, a rectifier, a voltage regulator, etc. and may be configured for connection with an external power source for charging the at least one rechargeable battery 161. For example, the device 101 may include a cable for connecting the charging circuit 162 to an outlet in a building. In some embodiments, the charging circuit 162 may further include a Universal Serial Bus (USB) port 163, allowing the device 101 to be connected to the external power source via USB cable.

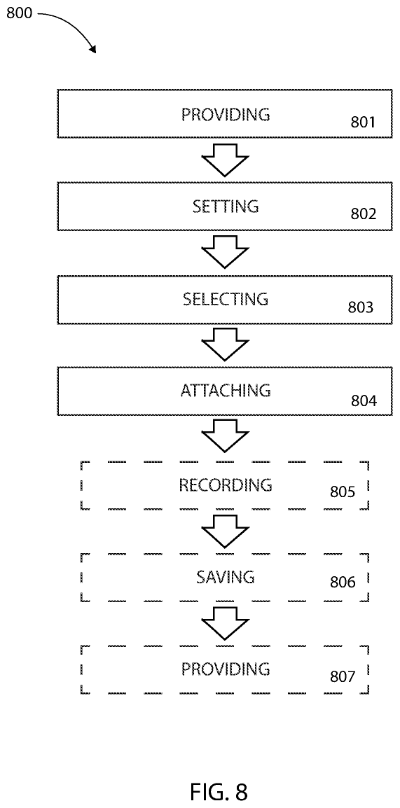

Referring now to FIG. 8 showing a flow diagram illustrating a method 800 of using a system for toilet training a child, according to an embodiment of the present disclosure. In particular, the method 800 may include one or more components or features of the system 100 as described above. As illustrated, the method 800 may include the steps of: step one 801, providing the system as above; step two 802, setting the at least one predetermined time interval; step three 803, selecting at least one of the at least one voice message and the at least one pre-recorded message, thereby allowing the loudspeaker unit to play the at least one of the at least one voice message and the at least one pre-recorded message once the at least one predetermined time interval has elapsed; and step four 804, attaching the device to one of a wrist of the child, clothing of the child and a belonging of the child. Further steps may include: step five 805, recording the at least one voice message via the recorder unit; and step six 806, saving the at least one voice message to the memory unit.

An additional step may include: step seven 807, providing the software application as above. At least one of the steps of setting 802 the at least one predetermined time interval, selecting 803 at least one of the at least one voice message and the at least one pre-recorded message, recording 805 the at least one voice message via the recorder unit and saving 806 the at least one voice message to the memory unit may be accomplished via the software application.

It should be noted that certain steps are optional steps and may not be implemented in all cases. Optional steps of method 800 are illustrated using dotted lines in FIG. 8 so as to distinguish them from the other steps of method 800. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using a system for toilet training a child are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A system for toilet training a child, the system comprising:
a device including:
a housing including a front side opposite a rear side;
a display located on the front side of the housing;
a user interface located about the display;
a recorder unit disposed within the housing, the recorder unit configured to record at least one voice message;
a loudspeaker unit disposed within the housing, the loudspeaker unit configured to audibly play at least one of the at least one voice message and at least one pre-recorded message; and
a control unit disposed within the housing and in communication with the recorder unit and the loudspeaker unit, the control unit including a timer unit and a memory unit, the memory unit configured to store the at least one of the at least one voice message and the at least one pre-recorded message, the timer unit configured to count down at least one predetermined time interval and cause the loudspeaker unit to play the at least one of the at least one voice message and the at least one pre-recorded message once the at least one predetermined time interval has elapsed, the timer unit automatically resetting back to count down of the at least one predetermined time interval once the at least one the predetermined time interval has elapsed; and
a power source configured to provide power to the device.

2. The system of claim 1, wherein the device further comprises a strap configured for attachment to the housing.

3. The system of claim 2, wherein the device is arranged as a watch, and wherein the strap is a watch strap configured to attach the device to a wrist of the child.

4. The system of claim 2, wherein the strap includes a fastener.

5. The system of claim 4, wherein the fastener is configured to attach the strap to at least one of clothing of the child and a belonging of the child.

6. The system of claim 1, wherein the display includes a digital display.

7. The system of claim 6, wherein the user interface is used by a parent to at least begin recording of the at least one voice message and set the at least one predetermined time interval.

8. The system of claim 1, wherein the control unit is further configured to receive information regarding completion of a toilet training task and actuate a reward setting based on the information.

9. The system of claim 8, wherein at least one of the at least one recorded message and the at least one pre-recorded message includes at least one reward message, and wherein the reward setting includes the control unit causing the loudspeaker unit to audibly play the at least one reward message.

10. The system of claim 1, wherein the power source includes at least one rechargeable battery, wherein the device further includes a charging circuit disposed in the housing, the charging circuit configured for connection with an external power source for charging the at least one rechargeable battery.

11. The system of claim 10, wherein the charging circuit further include a Universal Serial Bus (USB) port.

12. The system of claim 1, further comprising a software application configured for communication with the device.

13. The system of claim 1, further comprising a sticker book.

14. A system for toilet training a child, the device comprising:
a device including:
a housing including a front surface opposite a rear surface;
a strap configured for attachment to the housing, the strap including a fastener configured to fasten the device to one of a wrist of the child, clothing of the child and a belonging of the child;
a digital display located on the front surface of the housing;
a recorder unit disposed within the housing, the recorder unit configured to record at least one voice message;
a loudspeaker unit disposed within the housing, the loudspeaker unit configured to audibly play at least one of the at least one voice message and at least one pre-recorded message;
a control unit disposed within the housing and in communication with the recorder unit and the loudspeaker unit, the control unit including a timer unit and a memory unit, the memory unit configured to store the at least one of the at least one voice message and the at least one pre-recorded message, the timer unit configured to count down at least one predetermined time interval and cause the loudspeaker unit to play the at least one of the at least one voice message and the at least one pre-recorded message once the at least one predetermined time interval has elapsed, the timer unit automatically resetting back to count down of the at least one predetermined time interval once the at least one the predetermined time interval has elapsed;
a user interface located about the digital display, the user interface used by a parent to at least begin recording of the at least one voice message and set the at least one predetermined interval; and
a power source configured to provide power to the device; and
a software application configured for communication with the device.

15. The system of claim 14, further comprising a sticker book.

16. The system of claim 14, wherein the control unit is further configured to receive information regarding completion of a toilet training task and actuate a reward setting based on the information, wherein at least one of the at least one recorded message and the at least one pre-recorded message includes at least one reward message, and wherein the reward setting includes the control unit causing the loudspeaker unit to audibly play the at least one reward message.

17. The system of claim 16, wherein the power source includes at least one rechargeable battery, wherein the device further includes a charging circuit disposed in the housing, the charging circuit configured for connection with an external power source for charging the at least one rechargeable battery, and wherein the charging circuit includes a Universal Serial Bus (USB) port.

18. A method of using a system for toilet training a child, the system comprising the steps of:
providing the system including:
a device having:
a housing including a front side opposite a rear side;
a display located on the front side of the housing;
a user interface located about the display;
a recorder unit disposed within the housing, the recorder unit configured to record at least one voice message;
a loudspeaker unit disposed within the housing, the loudspeaker unit configured to audibly play at least one of the at least one voice message and at least one pre-recorded message; and
a control unit disposed within the housing and in communication with the recorder unit and the loudspeaker unit, the control unit including a timer unit and a memory unit, the memory unit configured to store the at least one of the at least one voice message and the at least one pre-recorded message, the timer unit configured to count down at least one predetermined time interval and cause the loudspeaker unit to play the at least one of the at least one voice message and the at least one pre-recorded message once the at least one predetermined time interval has elapsed, the timer unit automatically resetting back to count down of the at least one predetermined time interval once the at least one the predetermined time interval has elapsed; and
a power source configured to provide power to the device.
setting the at least one predetermined time interval;
selecting at least one of the at least one voice message and the at least one pre-recorded message, thereby allowing the loudspeaker unit to play the at least one of the at least one voice message and the at least one pre-recorded message once the at least one predetermined time interval has elapsed; and
attaching the device to one of a wrist of the child, clothing of the child and a belonging of the child.

19. The method of claim 18, further comprising the steps of:
recording the at least one voice message via the recorder unit; and
saving the at least one voice message to the memory unit.

20. The method of claim 19, wherein the system further comprises the step of providing a software application configured for communication with the device, and wherein at least one of the steps of setting the at least one predetermined time interval, selecting at least one of the at least one voice message and the at least one pre-recorded message, recording the at least one voice message via the recorder unit and saving the at least one voice message to the memory unit is accomplished via the software application.
